(19) United States
(12) Patent Application Publication
(10) Pub. No.: US 2015/0304176 A1
(43) Pub. Date: Oct. 22, 2015

(54) METHOD AND SYSTEM FOR DYNAMIC INSTANCE DEPLOYMENT OF PUBLIC CLOUD

(71) Applicants: INDUSTRIAL TECHNOLOGY RESEARCH INSTITUTE, Hsinchu (TW); NATIONAL CHIAO TUNG UNIVERSITY, Hsinchu (TW)

(72) Inventors: Wei-Chih TING, Taichung City (TW); Jun-Zhe WANG, Nantou County (TW); Chia-Min CHEN, Kaohsiung City (TW); Jiun-Long HUANG, Taipei City (TW)

(73) Assignees: INDUSTRIAL TECHNOLOGY RESEARCH INSTITUTE, Hsinchu (TW); NATIONAL CHIAO TUNG UNIVERSITY, Hsinchu (TW)

(21) Appl. No.: 14/511,647

(22) Filed: Oct. 10, 2014

(30) Foreign Application Priority Data
Apr. 22, 2014 (TW) 103114547

(51) Int. Cl. H04L 12/24; H04L 29/06; H04L 29/08

(52) U.S. Cl. CPC H04L 41/5054; H04L 67/10; H04L 67/42; H04L 67/16

(57) ABSTRACT

According to one exemplary embodiment, a method for dynamic instance deployment of public cloud uses a load monitor to obtain a current server deployment, wherein the current server deployment at least includes, for each server of a plurality of servers, an identity information of the server, and a number of current connections of the server, a server instance type of the server, and a located area of the server; and uses a scaling engine to determine whether there is at least one server of the plurality of servers satisfies at least one trigger condition, add the at least one server that satisfies the at least one trigger condition into a server candidate set, and receive an information of a performance cost ratio to perform a server scaling procedure for at least one area according to the server candidate set.

### CROSS-REFERENCE TO RELATED APPLICATION

The present application is based on, and claims priority from, Taiwan Patent Application No. 103114547 filed on Apr. 22, 2014, the disclosure of which is hereby incorporated by reference herein in its entirety

### TECHNICAL FIELD

The technical field generally relates to a method and system for dynamic instance deployment of public cloud.

### BACKGROUND

Webcast services have been mushroomed for recent years. Users may watch live videos such as online games, entertainment, news, sports program, technology via the Internet. With the popularity of online streaming, these streaming services require more and more bandwidth to operate. A peer-to-peer (P2P) network may use a mutual data sharing approach among peers, to increase the efficiency of streaming transmission. In a P2P network, many factors affects the quality of video such as user leaving and joining, low computational power of user equipment, insufficient bandwidth of user equipment, the distance between the video source and the user equipment. To overcome the variance, an architecture combining relaying servers and the P2P network is a good way to maintain the viewing quality for users.

With the popularity of mobile devices such as a hand-held video camera device, any user can become a streaming source. Both streamers and viewers can start from anywhere anytime. With the trend, the workload of a server increases rapidly, a streaming service company may work with a public cloud provider to build a distributed server group within the public cloud, and initiate variable number of relaying servers to meet flexible demands. For example, the streaming service company may pre-analyze the maximum simultaneous on-line users, and pre-establish sufficient virtual machines (VMs) from the public cloud.

Even if the estimation of the number and the behavior of users are achievable, a large number of standby servers are still needed to deliver the same viewing quality at peak time. With the doubt of quality degradation, the streaming service company still can't turnoff idle servers rashly during off-peak time. In many live broadcasting events, we always find idle servers with a low connection number. Money wastes on idle servers have been widening. Therefore, how to find an automatic way to minimize costs while maintaining satisfying viewing quality has become an important issue.

Auto-scaling may be done by vertical scaling and horizontal scaling. The vertical scaling is to modify hardware resources, such as increasing central processing unit (CPU) and/or Memory and/or bandwidth, while the number of servers remains unchanged. The horizontal scaling is to increase or decrease the number of servers, while the hardware specification of servers remains unchanged. Horizontal scaling is usually done by templates, server image, snapshots, or command-line scripts predefined by the public cloud provider and will establish many virtual machines of the same specification. At present, some cloud providers may require the tenant to preset some servers as an auto-scaling group in advance, wherein only servers within the group have the auto-scaling function. Some cloud providers may provide the tenant the ability to conduct benchmarking for different server instance types. One of implementations may utilize measuring the service completion time to find out which server instance type has the best performance cost ratio, and then perform the auto-scaling by setting a policy, which may be threshold-triggered or time-triggered.

The existing dynamic server scaling technologies may be divided into two categories. One category is that public cloud providers provide a reactive instance allocation mechanism at infrastructure-level to serve a large amount of tenants. Such techniques measure the current memory usage or network usage of servers, and provide a variety of metrics for tenants to choose. Auto-scaling is based on a threshold value. The threshold value may be set by users (public cloud tenants), or by using default best practices. A load balancer adjusts the workload of these servers belongs to the scaling group. The other category is based on the application characteristics of each tenant itself to determine a service pressure at application-level, and set business logic through an application programming interface (API) of the public cloud providers. This category of technologies is mostly proactive and may predict future workloads. The reference metrics for the technologies may be a number queued data, an average response time of these data, a number of network connections and so on.

There is a technology that provides a tightly integrated automatic management including inter-cloud automation management, which allows users to set various templates, macros, scripts, etc., performance metrics may be arranged into an array, and the scaling logic is determined by the tenant itself. There is a technology that provides a two-dimensional matrix of these metrics to train an active artificial neural network. The artificial neural network will determine whether auto-scaling should take action or not. There is a technology that considers a navigation route when access a website, and finds out the route with the heaviest pressure and perform auto-scaling on related servers of the route. There is a technology that provides a two-tier application service solution, and this technology observes the reaction effectiveness of the first layer through a linkage system, to decide whether the second layer should scale-up. There is a technique that controls a load balancer to arrange and dispatch workload to other servers based on an overall flow state of the current virtual machines (VMs). Some technologies suggest turning off the VMs according to a billing cycle.

There is a technology that considers a best balance between a penalty fee and a saving cost by trying to break the service level agreements (SLA) with tenants. This technology may be used by multi-tier applications. The scaling method is based on predicting the application capacity and considering the cost model and the resource model. All requests will go through a service gateway or a load balancer. Most virtual machines (VMs) have a same general resource allocation, wherein part of these virtual machines has a lower resource allocation. When the application capacity needs to scale up, the virtual machines of the lower resource allocation are vertically scaled up to a general resource allocation. When the application capacity needs to scale down, a vertical or horizontal scaling is performed to scale down one or more virtual machines to the lower resource allocation.

In the existing server dynamic scaling technologies, some technologies do not estimate the impact to the service provider (the tenant) after turning off the server(s). Some technologies only turn off a machine selected from a group of machines according to the status of a previous server. Some technologies cannot completely control which server should take the workload even with a load balancer. Some technologies do not fully utilize characteristics of the public cloud for cost saving, such as different pricing of data centers, the least billing cycle of the public cloud where an hourly fee is still charged for less than one hour, the combination of multiple public cloud providers, and so on. Therefore, how to find an automatic way to minimize costs while maintaining satisfying viewing quality has become an important issue is a worthy topic.

### SUMMARY

The embodiments of the present disclosure may provide a method and system for dynamic instance deployment of public cloud.

An exemplary embodiment relates to a method for dynamic instance deployment of public cloud. The method may comprise: obtaining, by a load monitor, a current server deployment, and the current server deployment at least including, for each server of a plurality of servers, an identity information of said server, a number of current connections of said server, a server instance type of said server, and a located area of said server; determining, by a scaling engine, whether there is at least one server of the plurality of servers satisfies at least one trigger condition; adding, by the scaling engine, the at least one server that satisfies the at least one trigger condition into a server candidate set; and receiving, by the scaling engine, an information of a performance cost ratio, and performing, by the scaling engine, a server scaling procedure for at least one area according to the server candidate set.

Another embodiment relates to a system for dynamic instance deployment of public cloud. This system may comprise a load monitor and a scaling engine. The load monitor obtains a current server deployment, wherein the current server deployment at least includes, for each server of a plurality of servers, an identity information of said server, a number of current connections of said server, a server instance type of said server, and a located area of said server. The scaling engine determines whether there is at least one server of the plurality of servers satisfies at least one trigger condition, adds the at least one server that satisfies the at least one trigger condition into a server candidate set, receives an information of a performance cost ratio, and performs a server scaling procedure for at least one area according to the server candidate set.

The foregoing will become better understood from a careful reading of a detailed description provided herein below with appropriate reference to the accompanying drawings.

### BRIEF DESCRIPTION OF THE DRAWINGS

FIG. 1 shows an example for the definition of a rental fee rate of a public cloud, according to an exemplary embodiment of the disclosure.

FIG. 2 shows a schematic view for the trigger timing of a scaling procedure of servers, according to an exemplary embodiment of the disclosure.

FIG. 3 shows a method for dynamic instance deployment of public cloud, according to an exemplary embodiment of the disclosure.

FIG. 4A shows a system for dynamic instance deployment of public cloud, according to an exemplary embodiment of the disclosure.

FIG. 4B shows an application scenario for the system in FIG. 4A, according to an exemplary embodiment of the disclosure.

FIG. 4C shows an example of areas divided by the round-trip time of a packet, according to an exemplary embodiment of the disclosure.

FIG. 5A shows the information of unit price of each connection corresponding to each server instance type of an area, according to an exemplary embodiment of the disclosure.

FIG. 5B shows the information of a maximum number of connections corresponding to each server instance type of an area, according to an exemplary embodiment of the disclosure.

FIG. 6 shows an operation flow of a server scaling in each of at least one area, according to an exemplary embodiment of the disclosure.

FIG. 7 shows an operation on how to calculate a target deployment of an area, according to an exemplary embodiment of the disclosure.

FIG. 8A and FIG. 8B show the server scaling procedure in an area, wherein FIG. 8A shows the state information of each server in the area before an adjustment, FIG. 8B shows the state information of each server in the area after the adjustment, according to an exemplary embodiment of the disclosure.

FIG. 9 shows an operation flow of an inter-area server scaling down, according to an exemplary embodiment of the disclosure.

FIG. 10 shows a relationship between selecting a t value and a percentage of the number of inter-area connections over the total number of connections, also between selecting the t value and a saving cost ratio, according to an exemplary embodiment of the disclosure.

### DETAILED DESCRIPTION OF THE DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

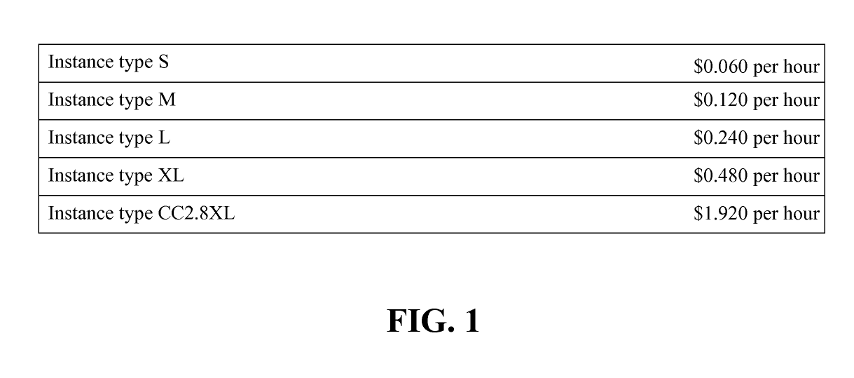

According to the exemplary embodiments in the disclosure, a method and system for dynamic instance deployment of public cloud is provided. The technology for the method and system collects the deployment state of all servers currently in one or more public clouds, and performs efficiency measurement for considering services to the tenants (who lease servers from public cloud providers) on the one or more public clouds, so as to understand such as a number of connections and a located area etc., of each server instance type of various server instance types, wherein a public cloud has at least one server. FIG. 1 shows an example for the definition of a rental fee rate of a public cloud, according to an exemplary embodiment of the disclosure. In the exemplary embodiment of FIG. 1, the rental fee rate may be charged by server instance types (i.e., small, medium, large, super large, CPU enhancement, denoted as instance type S, instance type M, instance type L, instance type XL and instance type CC2.8XL respectively). For example, the rental fee rate of instance type S is $0.060 per hour, the rental fee rate of instance type M is $0.120 per hour, the rental fee rate of instance type L is $0.240 per hour, the rental fee rate of instance type XL is $0.480 per hour, and the rental fee rate of instance type CC2 0.8 XL is $1.920 per hour.

The tenant may calculate the performance cost ratio of each server instance type according to the numbers of connections of these servers. The tenant may set at least one trigger condition according to a service request. According to an exemplary embodiment of the disclosure, the server that satisfies one of the at least one trigger condition may be added into a server candidate set. When the situation that satisfies the trigger condition occurs, a server scaling procedure is performed for at least one area according to the inputted information of a performance cost ratio and the server candidate set.

According to an exemplary embodiment of the present disclosure, the at least one trigger condition may be set as one or more combinations of trigger conditions, wherein the trigger conditions may be described as follows. Triggers when one or more operation statuses of a server reaches a threshold value; or triggers at one or more o'clock sharps; or triggers when a server is going to finish a billing cycle within a time interval; or triggers periodically with a fixed time interval. For example, the at least one trigger condition may be set to trigger when an idle rate or a resource utilization rate of the CPU, the memory or the bandwidth of a server reaches a threshold value; or triggers at 2 o'clock sharp or at 3 o'clock sharp or at 5 o'clock sharp or at 12 o'clock sharp and so on, but not limit to trigger at every o'clock sharp; or triggers on every Wednesday; or triggers when a server is going to finish a billing cycle; or triggers every minute. The idle rate is generally defined as one minus the resource utilization rate.

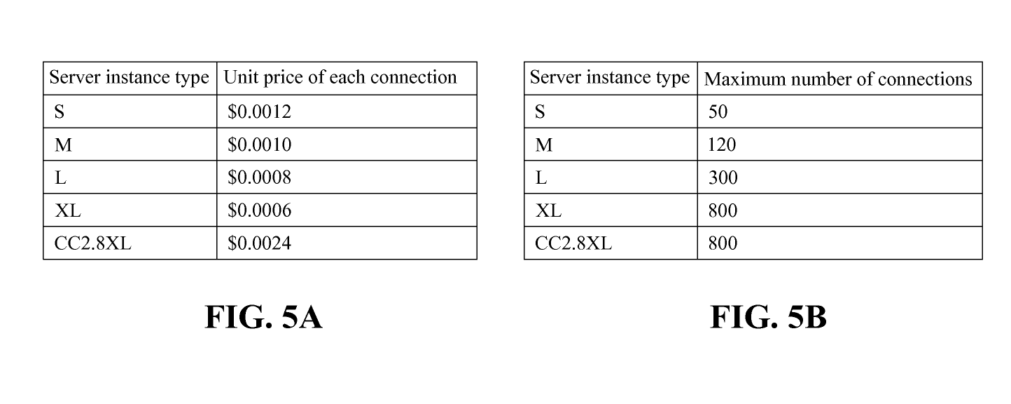

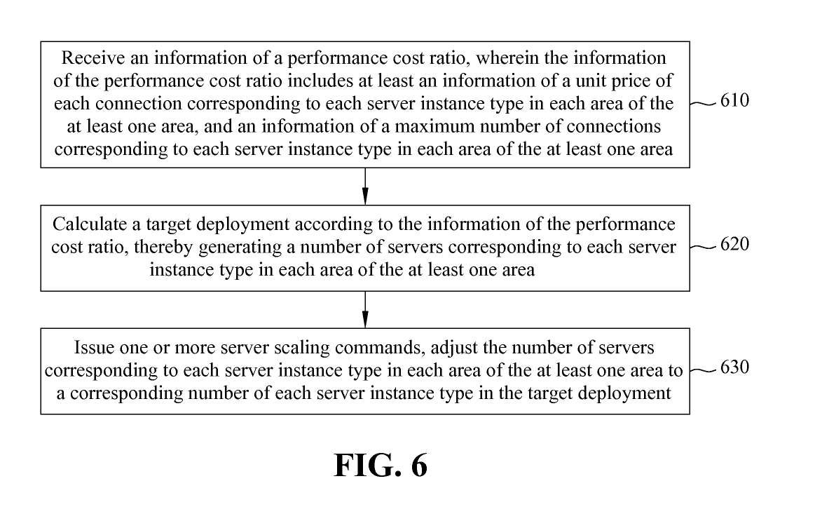

According to an exemplary embodiment, the definition of the performance cost ratio is an averaged unit price required of each connection. FIG. 5A shows an application exemplar for defining the performance cost ratio, according to an exemplary embodiment of the disclosure. In the exemplar of FIG. 5A, the performance cost ratio may be defined for five instance types (i.e., small, medium, large, super large, CPU enhancements, denoted as instance type S, instance type M, instance type L, instance type XL, instance type CC2.8XL respectively). For example, the performance cost ratio of instance type S is $0.0012 per hour, the performance cost ratio of instance type M is $ 0.0010 per hour, the performance cost ratio of instance type L is $0.0008 per hour, the performance cost ratio of instance type XL is $0.0006 per hour, and the performance cost ratio of instance type CC2 0.8 XL is $0.0024 per hour. In the exemplar of FIG. 5B, the maximum number of connections for instance type S is 50 servers, the maximum number of connections for instance type M is 120 servers, the maximum number of connections for instance type L is 300 servers, the maximum number of connections for instance type XL is 800 servers, and the maximum number of connections for instance type CC2.8XL is 800 servers. A server may be such as one or more combinations of virtual machines, hosts, etc. For tenants, the performance cost ratio of each instance type needs to be evaluated by themselves, the higher the performance cost ratio the better.

As aforementioned, when there is at least one server that satisfies the at least one trigger condition, a server scaling procedure of an area may be performed based on the inputted information of the performance cost ratio and the server candidate set. Examples for performing a server scaling up may be such as adding a server with a high performance cost ratio in an area, or adding a server of a smallest instance type, or adding a server of a largest instance type, or adding a server of a largest instance type with a maximum number of connections, and then wait for a next trigger condition. Examples for performing a server scaling down may be such as turning off a server with a lower resource utilization rate, or turning off a server with a low performance cost ratio, thereby resulting users reconnect to other servers with a high performance cost ratio.

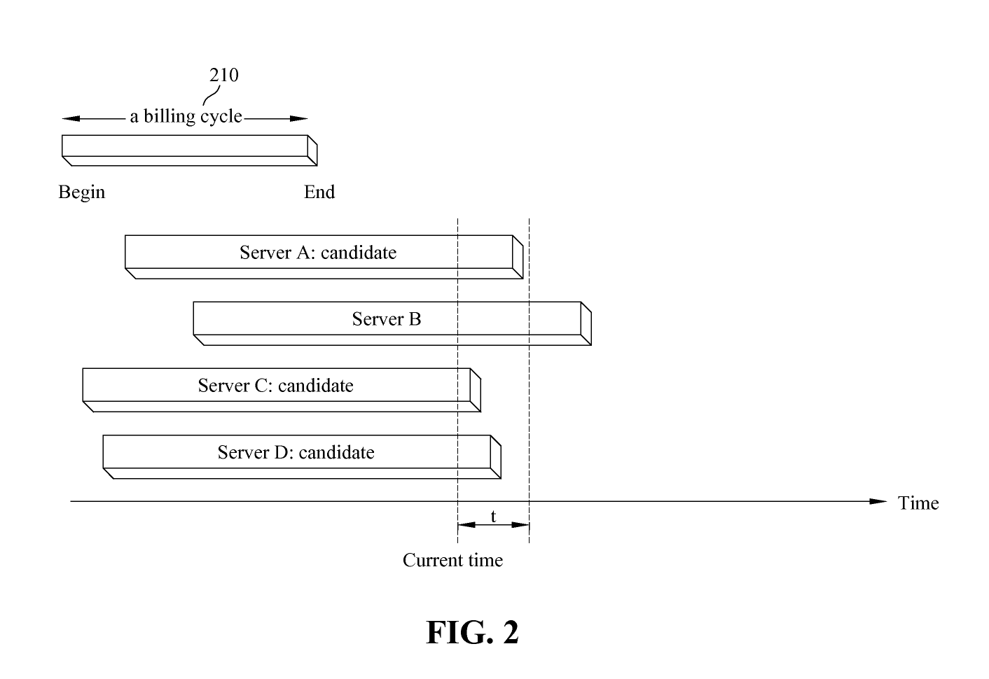

When the number of users gradually decreased with the lapse of time, the number of idle servers is increased. According to an exemplary embodiment of the present disclosure, servers of low performance cost ratios may be turned off; thereby allowing users to reconnect to other servers with high performance cost ratios to save money. The trigger timing of the server scaling procedure is such as triggering when an idle rate of CPU, memory, or bandwidth, etc., reaches a threshold value (for example, takes a CPU idle rate of 80% and 20%, respectively, as upper and lower thresholds), or triggering at o'clock sharp, or triggering when any server is going to finish a billing cycle, or triggering per minute. The triggering may add all current servers into the server candidate set, or add the server which is going to finish the billing cycle into the server candidate set. FIG. 2 shows a schematic view for the trigger timing of a scaling procedure of servers, according to an exemplary embodiment of the disclosure, wherein a billing cycle of a server is denoted by a reference 210.

In FIG. 2, it is considered to add at least one server which is going to finish a billing cycle into a reducing candidate set. An exemplary implementation method may set a threshold t, and add at least one server which is going to finish a billing cycle in t minutes into the server candidate set. In the exemplar of FIG. 2, according to this threshold t, server A, server C, and server D are all candidates that are going to finish their billing cycles, respectively. Therefore, server A, server C, and server D may also trigger the server scaling procedure. In other words, according to the exemplary embodiments of the present disclosure, the server scaling procedure may be conditionally triggered.

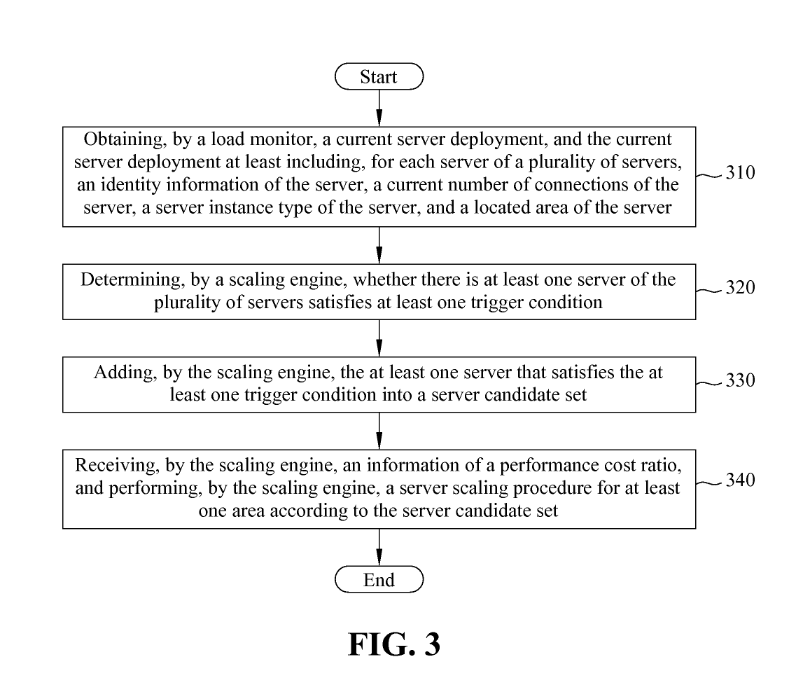

FIG. 3 shows a method for dynamic instance deployment of public cloud, according to an exemplary embodiment. Referring to FIG. 3, this method may comprise: obtaining, by a load monitor, a current server deployment, and the current server deployment at least including, for each server of a plurality of servers, an identity information of the server, a number of current connections of the server, a server instance type of the server, and a located area of the server (step 310); determining, by a scaling engine, whether there is at least one server of the plurality of servers satisfies at least one trigger condition (step 320); adding, by the scaling engine, the at least one server that satisfies the at least one trigger condition into a server candidate set (step 330); and receiving, by the scaling engine, an information of a performance cost ratio, and performing, by the scaling engine, a server scaling procedure for at least one area according to the server candidate set (step 340). The server candidate set of the at least one server selected from the current server deployment also includes the identity information of each server in the server candidate set, a number of current connections of the server, a server instance type of the server, and a located area of the server.

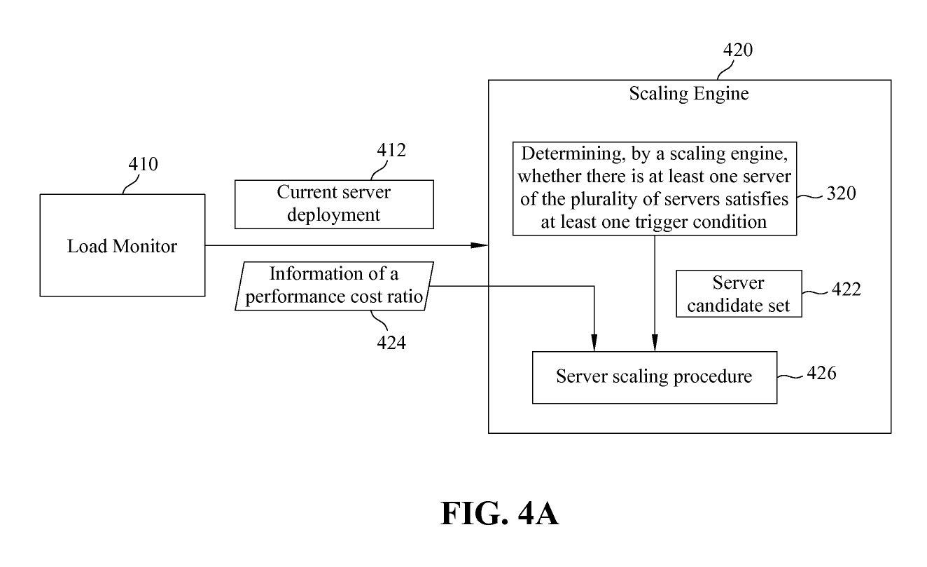

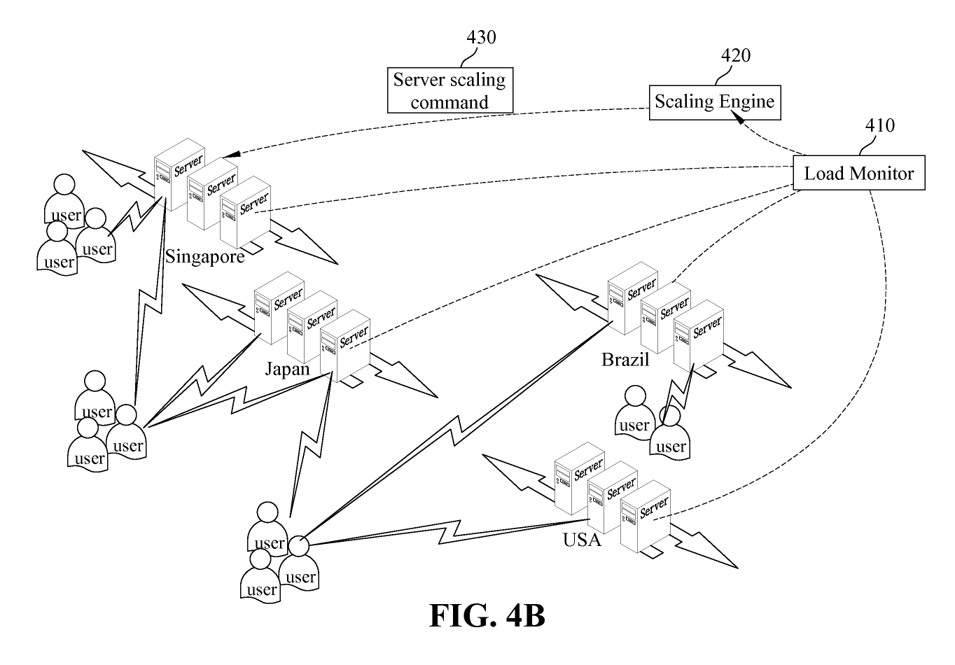

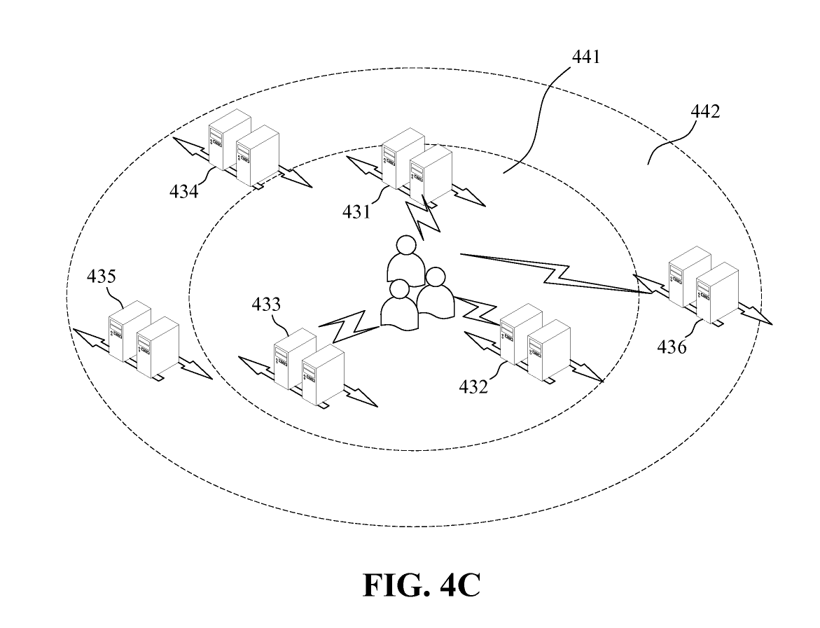

Accordingly, FIG. 4A shows a system for dynamic instance deployment of public cloud 400, according to an exemplary embodiment of the present disclosure. The system for dynamic instance deployment of public cloud 400 may comprise a load monitor 410 and a scaling engine 420. The load monitor 410 obtains a current server deployment 412, and the current server deployment 412 at least includes, for each server of a plurality of servers, an identity information of the server, a number of current connections of the server, a server instance type of the server, and a located area of the server. The scaling engine 420 determines whether there is at least one server of the plurality of servers satisfies at least one trigger condition, adds the at least one server that satisfies said at least one trigger condition into a server candidate set 422, and receives an information of a performance cost ratio 424, and performs a server scaling procedure 426 for at least one area according to the server candidate set 424. The server candidate set of the at least one server selected from the current server deployment also includes the identity information of each server in the server candidate set, a number of current connections of the server, a server instance type of the server, and a located area of the server.

FIG. 4B shows an application scenario for the system in FIG. 4A, according to an exemplary embodiment of the disclosure. In the exemplar of FIG. 4B, the load monitor 410 may obtain a current server deployment of one or more public clouds. This current server deployment is such as a current status information of a plurality of servers located in different areas (such as Singapore, Japan, USA, Brazil, . . . ). This status information includes at least an identity information of each server of the plurality of servers, a number of current connections of the server, a server instance type of the server, and a located area of the server. The identity information is such as an instance-id for distinguishing different servers. The scaling engine 420 obtains the status information from the load monitor 410. When there is at least one server of the plurality of servers satisfies at least one trigger condition (such as a server in Singapore), the scaling engine 420 may but not limited to issue one or more servers scaling commands 430 to servers located in this area (Singapore) to perform the server scaling procedure 426, and turn off the server(s) with a lower performance cost ratio, to make users reconnect to other server(s) with a higher performance cost ratio. Wherein the scaling down command may be such as “aws ec2 terminate-instances.” Wherein the scaling up command may be such as any combination of one or two or three of “aws ec2 run-instances”, “aws ec2 terminate-instances”, “aws ec2 modify-instance-attribute”. According to the exemplary embodiments of the present disclosure, the system for dynamic instance deployment of public cloud 400 may run on a single public cloud, may also run across multiple public clouds.

The term “area” in the present disclosure may be such as the area divided by the geographical location, or the area divided by the round trip time (RTT) of a packet between a user equipment and a server. FIG. 4C shows an example of areas divided by the round-trip time of a packet, according to an exemplary embodiment of the disclosure. In FIG. 4C, there are six cloud centers (denoted as cloud center 431˜cloud center 436) located at different locations, wherein the round trip time of a packet of each cloud center of cloud center 431˜cloud center 433 is less than or equal to 120 milliseconds (i.e., RTT≦120 ms), while the round trip time of a packet of each cloud center of cloud center 434˜cloud center 436 is less than or equal to 500 milliseconds and greater than 120 milliseconds (i.e., 120 ms<RTT≦500 ms). Accordingly, cloud center 431˜cloud center 433 are divided in an area 441, and cloud center 434˜cloud center 436 are divided in an area 442.

According to an exemplary embodiment of the present disclosure, the information of the performance cost ratio at least includes information of the unit price of each connection corresponding to each server instance type in each area of at least one area, and information of the maximum number of connections corresponding to each server instance type in each area of the at least one area. FIG. 5A shows the information of unit price of each connection corresponding to each server instance type of an area, according to an exemplary embodiment of the disclosure. The example of FIG. 5A illustrates the server with a better hardware specifications is not the one of the cheapest unit price, while the tenant may make their own performance evaluation for various server instance types. For example, leasing a clustered-CPU instance type may not help for multimedia applications. Its performance cost ratio is very low. In general, server instance types with better hardware specification such as server instance types L and XL may but not always get a higher performance cost ratio because of better bandwidth. For example, instance types M of Amazon Web Service will get moderate I/O performance and instance types XL will get high I/O performance. Some services may consume a huge memory, thus the server that is optimized for memory usage may be chosen for a higher performance cost ratio. FIG. 5B shows the information of a maximum number of connections corresponding to each server instance type of an area, according to an exemplary embodiment of the disclosure.

According to an exemplary embodiment, the server scaling procedure may be divided into two stages, wherein a first stage is intra-area server scaling, and a second stage is inter-area server scaling down. In other words, when there is a server that satisfies at least one trigger condition, an intra-area server scaling is performed for each area of the at least one area, and then an inter-area server scaling down is performed. According to the exemplary embodiments of the present disclosure, in the two-stage server scaling procedure, under the premise of without causing any inter-area connection, the first stage first minimizes the operating cost of servers within each area of the at least one area, thereby most users may be reconnected to the servers of the same area, and the server scaling procedure of the second stage may cause a small portion of users reconnect to servers in other areas. Thereby the server scaling procedure may achieve a balance on both saving the server cost and maintaining the user quality (in terms of reducing inter-area connections).

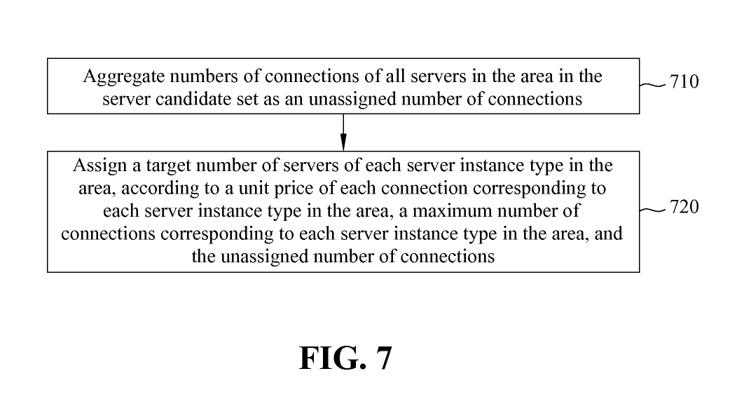

FIG. 6 shows an operation flow of a server scaling in each of the at least one area, according to an exemplary embodiment of the disclosure. Referring to FIG. 6, the scaling engine 420 receives an information of a performance cost ratio, wherein the information of the performance cost ratio includes at least an information of a unit price of each connection corresponding to each server instance type in each area of the at least one area, and an information of a maximum number of connections corresponding to each server instance type in each area of the at least one area (step 610); the scaling engine 420 calculates a target deployment according to the information of the performance cost ratio, thereby generating a number of servers corresponding to each server instance type in each area of the at least one area (step 620); and issues one or more server scaling commands, adjusts the number of servers corresponding to each server instance type in each area of the at least one area to a corresponding number of each server instance type in the target deployment (step 630). When turning off at least one server from a plurality of servers of a same server instance type is needed, the scaling engine may consider a turn off priority, but not limited to turn off the server of the lowest number of connections compared to that of the plurality of servers of the same server instance type.

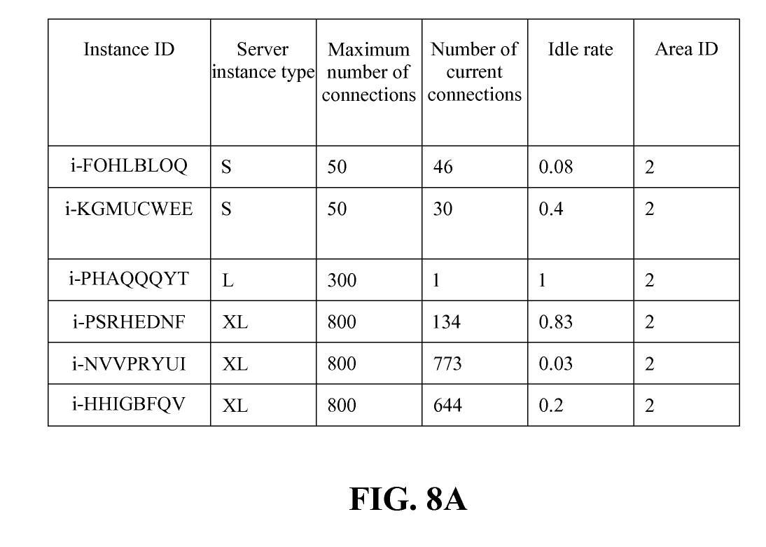

FIG. 7 shows an operation on how to calculate a target deployment of an area, according to an exemplary embodiment of the disclosure. Referring to FIG. 7, the scaling engine 420 aggregates numbers of connections of all servers in the area in the server candidate set as an unassigned number of connections (step 710); and assigns a target number of servers of each server instance type in the area, according to a unit price of each connection corresponding to each server instance type in the area, a maximum number of connections corresponding to each server instance type in the area, and the unassigned number of connections (step 720). The lower the unit price of each connection corresponding to a server instance type, the higher the performance cost ratio. There are many schemes for calculating the target number of servers corresponding to a server instance type. The following formula is an exemplary scheme.

A target number of servers corresponding to a server instance type=The unassigned number of connections/the maximum number of connections corresponding to the server instance type.

The unassigned number of connections is updated as follows.

The unassigned number of connections=The unassigned number of connections

Mod the maximum number of connections corresponding to the server instance type;
wherein Mod is a modulo operation.

In step 720, there are many implementation schemes for assigning the target number of servers corresponding to each server instance type in the area. According to an exemplary embodiment, for example, one scheme may orderly assign the target number of servers corresponding to each server instance type in the area, from the lowest unit price to the highest unit price corresponding to each connection of a plurality of server instance types in the area. Assuming a server that is in the area and is going to finish a billing cycle (60 minutes) in t minutes is added to a server candidate set, or all servers in the area are added to the server candidate set (i.e., t=60). Then a server scaling procedure for the area may be operated as following: aggregating numbers of connections of all servers in the server candidate set as an unassigned number of connections, by orderly assigning the unassigned number of connections to a server instance type of the highest performance cost ratio (each connection corresponding to a server instance type has the lowest unit price). For example, a server of XL instance type has the highest performance cost ratio and assumed be able to support up to 800 connections, [the unassigned number of connections/800] servers of XL instance type are assigned first. After the assignment, the unassigned number of connections is updated to [the unassigned number of connections Mod 800]. When the updated unassigned number of connections has not yet come to zero, then this process continues to assign the unassigned number of connections to a next server instance type, until the unassigned number of connections becomes zero. If the unassigned number of connections is less than a maximum number of connections corresponding to the server instance type, then the target number of servers of the server instance type is added by 1. An active tenant wanting to save cost may adjust the formula as abandoning the unassigned number of connections, and use the target number of servers of the server instance type instead. There are many schemes to implement this fine-tuning which is not contrary to the spirit of starting the assignment from server(s) of a high performance cost ratio. At this time a target deployment of an area has been completed (the target deployment also includes the number of servers corresponding to each server instance type in the area). Performing an adjustment according to a number difference between the target deployment and a current number of servers in the area may increase or decrease the servers of various instance types. When increasing at least one server is needed, the scaling engine 420 may directly increase the at least one server. When turning off at least one server is needed, the scaling engine 420 may use, but not limited to, a minimum edit distance (Levenshtein) as a principle for performing the adjustment of the number of servers, based on the number of current connections of the server. For example, if one of two servers of the same XL instance type is needed to be turned off, then the server currently with a fewer number of connections is chosen.

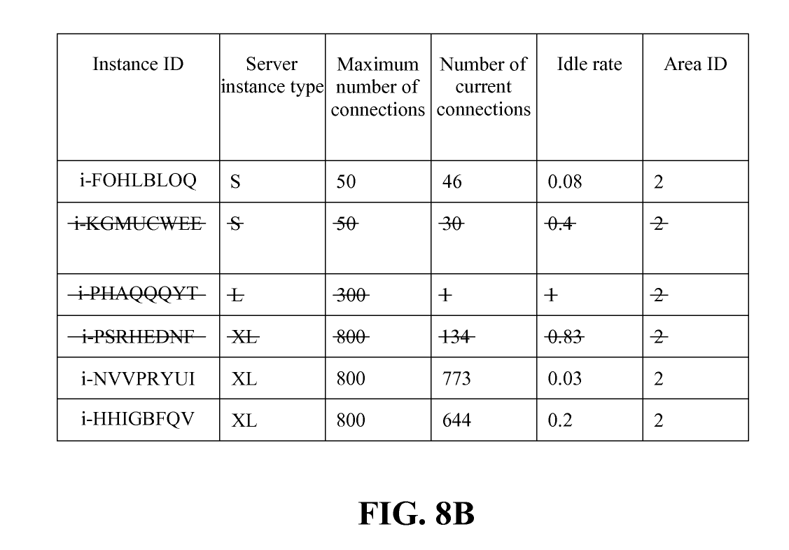

According to the aforementioned exemplary embodiments, FIG. 8A and FIG. 8B take an exemplar to illustrate the server scaling procedure in an area, wherein assuming that a total of 1628 user connections in an area in a server candidate set. FIG. 8A shows an example of a current server deployment of the area before an adjustment. After a tenant evaluates the performance, the tenant thinks the performance cost ratio of instance type XL is higher, and assigns, with a highest priority, a number of connections to the server of instance type XL, and then a target deployment in the area is calculated based on the operation flow of the target deployment and the exemplary formula of obtaining the target number of servers. The calculated target deployment for the area is two servers of instance type XL and one server of instance type S.

Therefore a server of instance type XL, a server of instance type L, and a server of instance type S should be turned off, according to the number differences between the target deployment and the current number of servers in the area. When turning off a server, the server of the same instance type with a minimum edit distance may be considered. For example, currently three servers of the same instance type XL are available for selection. According, the server(s) of instance type XL having the lowest number of current connections may be chosen to be turned off. Thereby, the server of instance type XL whose instance ID is i-PSRHEDNF (server of instance type XL having the lowest number of current connections), the server of instance type L whose instance ID is i-PHAQQQYT, and the server of instance type S whose instance ID is i-KGMUCWEE (server of instance type S having the lowest number of current connections) are turned off, as shown in FIG. 8B, the target deployment of the area after the adjustment, wherein the delete line represents turning off the server.

According to an exemplary embodiment, performing the scaling procedure in the second stage of inter-area server scaling down is based on the idle rates or the resource utilization rates of all servers in the server candidate set 422. For example, performing the scaling down may be based on the idle rates (from a highest to a lowest idle rate) of these servers or based on the resource utilization rates (from a lowest to a highest resource utilization rate) of these servers. One calculation method for the resource utilization rate of a server is such as the following exemplary formula:

The resource utilization rate=the ratio of the number of current connections of the server to the maximum number of connections corresponding to the server instance type of the server.

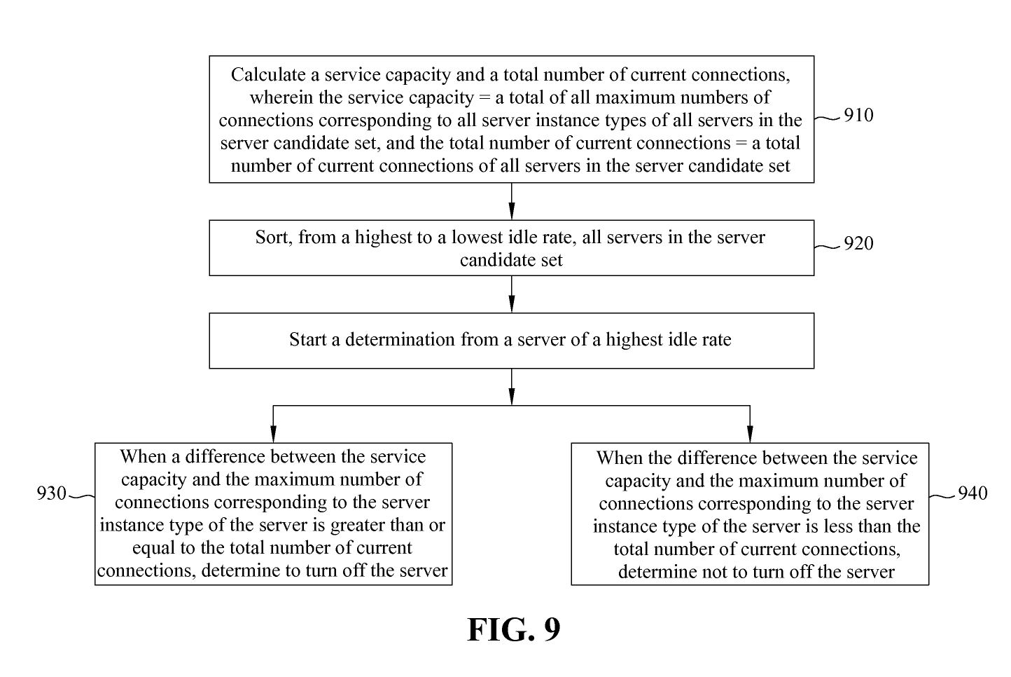

FIG. 9 shows an operation flow of an inter-area server scaling down, according to an exemplary embodiment of the disclosure. Referring to FIG. 9, the scaling engine 420 calculates a service capacity and a total number of current connections, wherein the service capacity=a total of all maximum numbers of connections corresponding to all server instance types of all servers in the server candidate set, and the total number of current connections=a total number of current connections of all servers in the server candidate set (step 910); sorts, from a highest to a lowest idle rate, all servers in the server candidate set (step 920); then, starts a determination from a server of a highest idle rate, and when a difference between the service capacity and the maximum number of connections corresponding to the server instance type of the server is greater than or equal to the total number of current connections, the scaling engine 420 determines to turn off the server (step 930). When the difference between the service capacity and the maximum number of connections corresponding to the server instance type of the server is less than the total number of current connections, the scaling engine 420 determines not to turn off the server (step 940). Until there is no server in the server candidate set can be turned off.

In other words, the inter-area server scaling down may determine whether to turn off a server according to a total of all maximum numbers of connections corresponding to all server instance types of all servers in the server candidate set, a total of numbers of current connections of all servers in the server candidate set, and the maximum number of connections corresponding to a server instance type of said server.

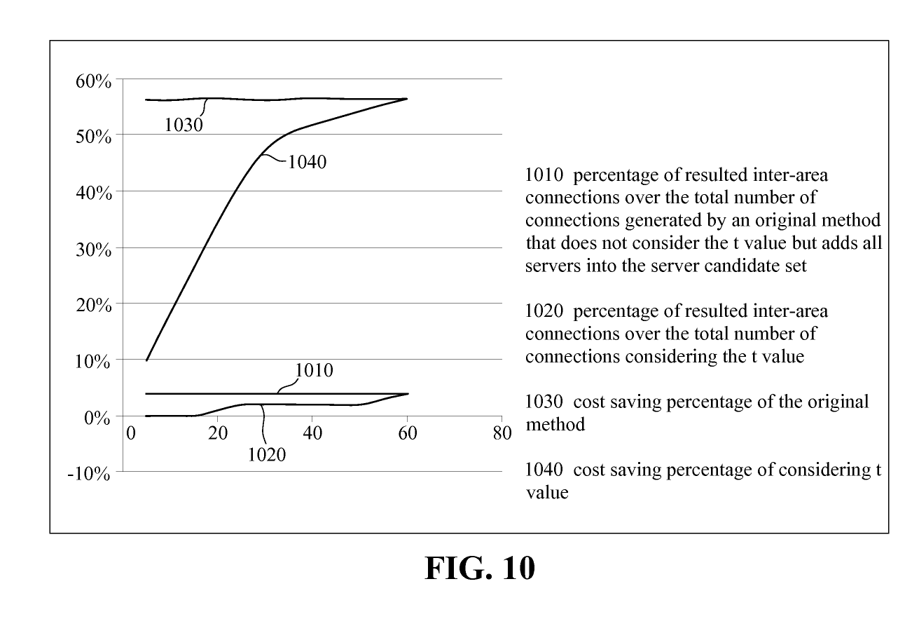

According to the technique for dynamic instance deployment of public cloud in the exemplary embodiment, the inter-area connections may be generated after the inter-area scaling down in the second stage. If a tenant does not want to generate any inter-area connection, the scaling engine 420 may be set to not perform the inter-area server scaling down procedure, but this may get a poor result for cost saving. FIG. 10 shows a relationship between selecting a t value and a percentage of resulted inter-area connections over the total number of connections, also between selecting the t value and a cost saving percentage, according to an exemplary embodiment of the disclosure. Wherein the horizontal axis represents the t value (unit: minute) and the vertical axis represents the percentage. A curve 1010 represents the percentage of resulted inter-area connections over the total number of connections generated by an original method that does not consider the t value but adds all servers into the server candidate set. A curve 1020 represents the percentage of resulted inter-area connections over the total number of connections considering the t value by adding only those servers which are going to finish a billing cycle in t minutes into the server candidate set. A curve 1030 represents the cost saving percentage of the original method. A curve 1040 represents the cost saving percentage of considering the t value.

Referring to FIG. 10, a curve 1040 shows that the higher the selected t value, the stronger the effect of cost saving generated by the inter-area server scaling down, at the expense of higher number of resulted inter-area connections. If the t value is set to 60 minutes, it means that all servers will be added into the server candidate set and will be determined by the scaling engine, which is equivalent to the original method. If the t values is selected to be 5 minutes, then the effect of cost saving is quite poor. If the t value is increased to be 10 minutes, then the effect of cost saving is significantly improved to be nearly doubled comparing to the case where t value is selected to be 5 minutes. When the t value is selected to be higher than 35 minutes, the marginal benefit of cost saving is diminished.

In summary, according to the exemplary embodiments of the disclosure, a method and system for dynamic instance deployment of public cloud is provided. The technique for dynamic instance deployment of public cloud uses a load monitor to obtain a current server deployment running on the public cloud to provide to a scaling engine. The scaling engine uses a trigger condition scheme to trigger a server scaling procedure, and dynamically adjusts the target number of servers for each server instance type, thereby reducing the operating cost of servers while maintaining the service quality of the tenant. This technique may run on a single public cloud, also may run across on a plurality of public clouds.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for dynamic instance deployment of public cloud, comprising:
obtaining, by a load monitor, a current server deployment, and the current server deployment at least including, for each server of a plurality of servers, an identity information of said server, a number of current connections of said server, a server instance type of said server, and a located area of said server;
determining, by a scaling engine, whether there is at least one server of the plurality of servers satisfies at least one trigger condition;
adding, by the scaling engine, the at least one server that satisfies the at least one trigger condition into a server candidate set; and
receiving, by the scaling engine, an information of a performance cost ratio, and performing, by the scaling engine, a server scaling procedure for at least one area according to the server candidate set.

2. The method as claimed in claim 1, wherein the information of the performance cost ratio at least includes an information of a unit price of each connection corresponding to each server instance type in each area of the at least one area, and an information of a maximum number of connections corresponding to each server instance type in each area of the at least one area.

3. The method as claimed in claim 1, wherein performing the server scaling procedure is performing a server scaling in each area of the at least one area, and then performing an inter-area server scaling down.

4. The method as claimed in claim 1, wherein the at least one trigger condition is set as one or more combinations of triggering when one or more operation statuses of the at least one server reaches a threshold value, triggering at one or more o'clock sharps, triggering when the at least one server is going to finish a billing cycle within a time interval, triggering periodically with a fixed time interval.

5. The method as claimed in claim 2, wherein the method further includes:
calculating a target deployment according to the information of the performance cost ratio, thereby generating a number of servers corresponding to the each server instance type in the each area of the at least one area; and
issuing one or more server scaling commands, and adjusting a current number of servers corresponding to the each server instance type in the each area of the at least one area to be a number of servers corresponding to the each server instance type in the target deployment.

6. The method as claimed in claim 5, wherein calculating the target deployment further includes:
aggregating numbers of connections of all servers in the each area of the at least one area in the server candidate set as an unassigned number of connections; and
assigning a target number of servers of each server instance type in the each area of the at least one area, according to the unit price of the each connection corresponding to the each server instance type in the area, the maximum number of connections corresponding to the each server instance type in the area, and the unassigned number of connections.

7. The method as claimed in claim 6, wherein the method orderly assigns the target number of servers of each server instance type in the each area of the at least one area, from a lowest unit price to a highest unit price of the each connection corresponding to the each server instance type in the each area of the at least one area.

8. The method as claimed in claim 1, wherein when turning off at least one server of a plurality of servers of a same server instance type is needed, the at least one server of a lowest number of current connections, compared to that of the plurality of servers of the same server instance type, is turned off.

9. The method as claimed in claim 3, wherein performing the inter-area server scaling down is performing a scaling down on all servers in the server candidate set, according to an idle rate or a resource utilization rate of each server of the all servers in the server candidate set.

10. The method as claimed in claim 9, wherein the idle rate is one minus the resource utilization rate, and the resource utilization rate is a ratio of a number of current connections of the server to a maximum number of connections corresponding to the server instance type of the server.

11. The method as claimed in claim 3, wherein performing the inter-area server scaling down is determining whether to turn off a server, according to a total of all maximum numbers of connections corresponding to all server instance types of all servers in the server candidate set, a total of numbers of current connections of all servers in the server candidate set, and a maximum number of connections corresponding to a server instance type of said server.

12. A system for dynamic instance deployment of public cloud, comprising:
a load monitor that obtains a current server deployment, wherein the current server deployment at least includes, for each server of a plurality of servers, an identity information of said server, a number of current connections of said server, a server instance type of said server, and a located area of said server; and
a scaling engine that determines whether there is at least one server of the plurality of servers satisfies at least one trigger condition, adds the at least one server that satisfies the at least one trigger condition into a server candidate set, receives an information of a performance cost ratio, and performs a server scaling procedure for at least one area according to the server candidate set.

13. The system as claimed in claim 12, wherein when there is at least one server of the plurality of servers satisfies the at least one trigger condition, the scaling engine issues one or more server scaling commands to the at least one server located in the at least one area to perform the server scaling procedure.

14. The system as claimed in claim 12, wherein the server scaling procedure is divided into two stages, wherein a first stage is an intra-area server scaling, and a second stage is an inter-area server scaling down.

15. The system as claimed in claim 12, wherein the at least one trigger condition is set as one or more combinations of triggering when one or more operation statuses of the at least one server reaches a threshold value, triggering at one or more o'clock sharps, triggering when the at least one server is going to finish a billing cycle within a time interval, triggering periodically with a fixed time interval.

16. The system as claimed in claim 12, wherein the scaling engine obtains an information of the current server deployment from the load monitor.

17. The system as claimed in claim 12, wherein the information of the performance cost ratio at least includes an information of a unit price of each connection corresponding to each server instance type in each area of the at least one area, and an information of a maximum number of connections corresponding to each server instance type in each area of the at least one area.

18. The system as claimed in claim 12, wherein the at least one server is one or more combinations of at least one virtual machine and at least one host.

19. The system as claimed in claim 12, wherein the system runs on one or more public clouds.
